(19) United States
(12) Patent Application Publication
(10) Pub. No.: US 2025/0386807 A1
(43) Pub. Date: Dec. 25, 2025

(54) Packaging container of waterless hibernated live fish and display case of waterless hibernated live fish

(71) Applicant: THE FISH CO., LTD., Pyeongtaek-si (KR)

(72) Inventor: Mun Seon GONG, Pyeongtaek-si (KR)

(21) Appl. No.: 19/208,582

(22) Filed: May 14, 2025

(30) Foreign Application Priority Data
Jun. 24, 2024 (KR) 10-2024-0082131

(51) Int. Cl. A01K 63/02

(52) U.S. Cl. CPC A01K 63/02

(57) ABSTRACT

The live fish packaging container according to the present invention is configured to have sufficient airtightness to inject and maintain oxygen for transportation, and each live fish can be individually packaged, transported, and immediately displayed on a display shelf for sale. Furthermore, the waterless hibernation live fish display case according to the present invention interfaces with the gas sensor unit of the packaged live fish containers to obtain information on the gas volume present in the internal space, and accordingly activates the oxygen injection means to inject oxygen into each live fish packaging container. By maintaining an appropriate temperature and supplying appropriate oxygen to each live fish packaging container, the quality of the product can be maintained in the best possible condition.

### CROSS-REFERENCES TO RELATED APPLICATION

The present application claims priority under 35 U.S.C. § 119 to Korean Patent Application No. 10-2024-0082131 filed on Jun. 24, 2024, in the Korean Intellectual Property Office, the disclosures of which are incorporated herein by reference in its entireties.

### TECHNICAL FIELD

The present invention relates to a live fish packaging container and a live fish display case, and more specifically, to a packaging container of waterless hibernated live fish (hereinafter also referred to as a ‘waterless hibernated live fish packaging container’) capable of packaging artificially waterless hibernated live fish in a waterless state, and a display case of waterless hibernated live fish (hereinafter also referred to as a ‘waterless hibernated live fish display case’) for displaying and selling the same.

### BACKGROUND ARTS

There are two main methods for transporting live fish: transporting them in tanks and transporting them in a waterless state.

However, when transporting live fish in tanks, the weight and volume of water result in high logistics costs. As a result, recent attention has shifted toward packaging live fish in a waterless state by inducing artificial hibernation.

In this context, Korean Registered Patent No. 10-2172591 describes a live fish packaging container having an upper surface-opened rectangular box shape with an upper end of the four sides formed with oxygen inlet grooves at a certain depth and width and including a fish storage space where two flounders are stored in opposite directions without touching each other, and a refrigerant storage space where refrigerant is stored.

However, the live fish packaging container of the aforementioned registered patent No. 10-2172591 is made of styrofoam, which has the problem of increasing in volume, and it is difficult to manufacture the packaging container with sufficient airtightness to individually inject and maintain oxygen in each packaging container.

Furthermore, with activation of waterless transportation of artificial-hibernation induced live fish, there is a growing need for various display case technologies that can maintain the good quality of artificially induced live fish during transportation and ensure efficient display and sales at various retail locations after transportation.

### RELATED PRIOR TECHNICAL DOCUMENT

### Patent Document

(1) Korean Registered Patent No. 10-2172591 (Title: live fish packaging method and live fish packing container, published date: Nov. 2, 2020)

### SUMMARY OF THE INVENTION

### Technical Subject

The present invention has been developed to solve the above problems, and its purpose is to provide a live fish packaging container that can be configured to reduce volume compared to conventional packaging containers made of styrofoam, while still being able to individually inject oxygen and maintain sufficient airtightness to retain the injected oxygen.

Another objective of the present invention is to provide a live fish display case that allows multiple live fish packaging containers to be displayed for sale, while also enabling the quality of the artificially hibernated live fish contained in each container to be maintained at the highest quality level.

### Technical Solution

To achieve the above objectives, the live fish packaging container according to the present invention may comprise: a main body part having an internal space capable of accommodating artificial hibernation-induced live fish into a waterless state, and an open upper surface; a lid part covering the open upper surface of the main body; an oxygen injection part formed on the main body part or the lid part to provide a passage for oxygen to be injected into the internal space of the main body part; and an oxygen exhaust part formed on the main body part or the lid part to allow oxygen injected into the internal space of the main body part to be exhausted.

Preferably but not necessarily, the live fish packaging container may further include one or more locking parts that are intermittently provided along the circumference of the main body part and the lid part and that serve to connect the main body part and the lid part.

Preferably but not necessarily, the live fish packaging container may include one or more gas sensor parts for measuring the gas volume in the internal space.

Preferably but not necessarily, the gas sensor part may include a sensor for measuring the oxygen volume.

The live fish display case according to the present invention is intended to display and sell a plurality of live fish packaging containers containing artificially-hibernated live fish, comprising: a cooling part for cooling a display space of a live fish display case; a display part for visually displaying various information; a detection part that detects whether the live fish packaging containers are displayed at each product display position, which is the location where each live fish packaging container is displayed; and a controller that displays information about the products displayed at each product display position through the display part based on the detection results of the detection part.

Preferably, but not necessarily, the controller may be configured to display time information elapsed after the live fish packaging containers were displayed at each product display position on the display part based on the detection results of the detection part.

Preferably, but not necessarily, the display part may be installed in a one-to-one correspondence with each product display position, or may be configured to display information about products displayed at two or more of the product display positions.

Preferably, but not necessarily, the live fish display case may be configured to include one or more shelves equipped with multiple product display positions.

Preferably, but not necessarily, the shelves may be installed at an angle such that a front end is lower than a rear end.

The live fish display case may further include a gas information acquisition part that interfaces with the gas sensor parts of the live fish packaging containers displayed at each product display location to obtain information on gas volume (amount of gas) present in the internal space of the live fish packaging containers.

Preferably, but not necessarily, the controller may be configured to display the gas volume information obtained through the gas information acquisition part on the display part.

Preferably, but not necessarily, the live fish display case may further include an oxygen injection means for injecting oxygen into the oxygen injection parts of each live fish packaging container displayed at each product display position.

Preferably, but not necessarily, the controller may be configured to control the oxygen injection means based on the gas volume information obtained through the gas information acquisition part.

### Advantageous Effects

The live fish packaging container according to the present invention can be made smaller in volume than conventional styrofoam packaging containers and can be configured to have sufficient sealing strength to allow individual injection of oxygen and maintain the injected oxygen.

Since each live fish packaging container is transported in a state where sufficient oxygen is filled, the quality of artificially hibernated live fish can be maintained for an extended period.

Furthermore, the live fish packaging container can be transparently constructed, allowing each live fish to be individually packaged, transported, and immediately displayed on a display shelf for sale.

The live fish display case according to the present invention can maintain the display space at a temperature that allows the live fish contained in each live fish packaging container to remain in optimal condition, while visually displaying various information about the live fish contained in each live fish packaging container, thereby facilitating consumer product selection and purchase.

Still furthermore, the live fish display case can be configured to supply appropriate oxygen to each live fish packaging container manually or automatically, thereby maintaining the quality of the live fish in each live fish packaging container at the optimal state.

### BRIEF DESCRIPTION OF DRAWINGS

FIG. 1 is a live fish packaging container with a main body and a lid part that can be separated according to an exemplary embodiment of the present invention.

FIG. 2 is a live fish packaging container with a main body and a lid part that are combined according to an exemplary embodiment of the present invention.

FIG. 3 is a sealed structure of the main body and the lid part according to an exemplary embodiment of the present invention.

FIG. 4 is a live fish display case according to the present invention.

FIG. 5 is a display part installed at each product display position according to an exemplary embodiment of the present invention.

FIG. 6 shows oxygen being automatically injected into each live fish packaging container according to an exemplary embodiment of the present invention.

### BEST MODE

The present invention is capable of various modifications and may have various embodiments. Therefore, specific embodiments are illustrated in the drawings and described in detail in the detailed description. However, this is not intended to limit the present invention to specific embodiments, and all modifications, equivalents, and substitutions included within the scope of the present invention should be understood as being included. In describing the present invention, detailed descriptions of related prior art that are deemed to obscure the essence of the present invention are omitted.

The terms used in this application are used solely to describe specific embodiments and are not intended to limit the scope of the present invention. Unless the context clearly indicates otherwise, singular expressions include plural expressions. In this application, terms such as ‘include’ or ‘have’ are intended to specify the presence of the features, numbers, steps, operations, components, parts, or combinations thereof described in the specification, and should not be interpreted as precluding the presence or possibility of one or more other features, numbers, steps, operations, components, parts, or combinations thereof.

The terms ‘first,’ ‘second,’ etc. may be used to describe various components, but the components should not be limited by these terms. These terms are used solely to distinguish one component from another.

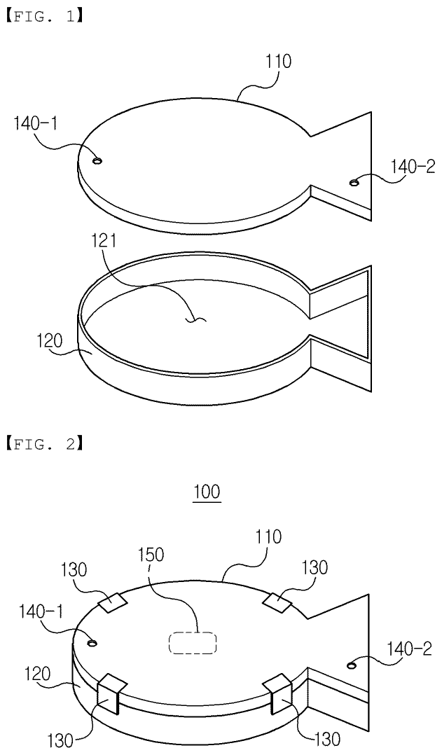

Referring to FIGS. 1 and 2, the live fish packaging container (100) according to the present invention is for packaging artificial-hibernation induced live fish in a waterless state, and may include a lid part (110), a main body part (120), an oxygen injection part (140-1), and an oxygen exhaust part (140-2).

In this specification, ‘live fish’ generally refers to living fish, and ‘artificial hibernation’ refers to the process of artificially inducing hibernation. The method of inducing artificial hibernation in live fish is not particularly limited and may include various methods known in this technical field, such as the method described in Korean Registered Patent No. 10-1863586 (Method for Inducing Artificial Hibernation in Fish and Packaging Container). Additionally, ‘waterless hibernation’ refers to hibernating fish without water or maintaining artificially hibernated fish in a waterless state. In this specification, ‘artificial hibernation’ and ‘waterless hibernation’ may be used interchangeably or with similar meanings.

The main body part (120) is configured with an internal space (121) to accommodate live fish induced into artificial hibernation in a waterless state, and is structured with an open upper surface.

Here, the internal space may have a volume sufficient to accommodate the artificial hibernation-induced live fish in a waterless state while maintaining a certain amount of air (oxygen).

The lid part (110) may serve to cover the open upper surface of the main body part (120).

Basically, the main body part (120) may include an internal space (121), but the internal space for accommodating live fish does not necessarily have to be formed solely through the main body (120). Depending on the need, the lid part (110) may also be configured to form the internal space.

The live fish packaging container (100) may be configured in various forms, taking into account various factors such as the type, size, and characteristics of the live fish to be packaged, the convenience of transportation, and design elements for display and sale at retail stores.

As a specific example, the live fish packaging container (100) may be configured according to the types or kinds of live fish to be packaged.

For example, if the live fish to be packaged is flounder, the outer appearance of the live fish packaging container (100) may be configured to resemble the shape of flounder.

Although FIGS. 1 and 2 show examples of the outer appearance of the live fish packaging container (100) configured in the shape of live fish, this is not limited to these examples.

The number of live fish that can be accommodated in the internal space of the live fish packaging container (100) may be varied, but if the container is designed to package one live fish per container, this can enhance the convenience of subsequent display and sales.

The material of the live fish packaging container (100) may be composed of various materials, and as a specific example, it can be composed using synthetic resin (plastic).

In particular, when considering display and sale at retail stores after transportation, it is desirable that at least the lid part (110) be made of a transparent material to allow consumers to directly see the live fish contained in the internal space.

The oxygen injection part (140-1) may be formed in the lid part (110) or the main body part (120) to provide a passage for oxygen to be injected into the internal space (121) from the outside.

The oxygen exhaust part (140-2) may be formed in the lid part (110) or the main body part (120) to allow oxygen injected into the internal space (121) through the oxygen injection part (140-1) to be exhausted.

The oxygen exhaust part (140-2) may be provided to ensure that oxygen injected through the oxygen injection part (140-1) spreads smoothly within the internal space. Without the oxygen exhaust part (140-2), oxygen injection may not occur smoothly due to internal pressure.

The oxygen injection part (140-1) and the oxygen exhaust part (140-2) may be formed as simple holes, but they may be configured in various ways to ensure smooth oxygen injection and exhaust through the devices used for oxygen injection.

For example, the oxygen injection part (140-1) and the oxygen exhaust part (140-2) may be designed to be manually opened and closed using a plug.

However, the oxygen injection part (140-1) may be configured to be in an open state when oxygen is injected and automatically closed when oxygen is not injected.

In addition, the oxygen exhaust part (140-2) may be configured to be in an open state when a certain pressure is applied due to oxygen injection and automatically closed when no pressure is applied.

The lid part (110) and the main body part (120) may be configured in various ways to ensure that the internal space (121) is sealed when they are mutually combined. In this case, various sealing technologies related to sealing containers may be applied.

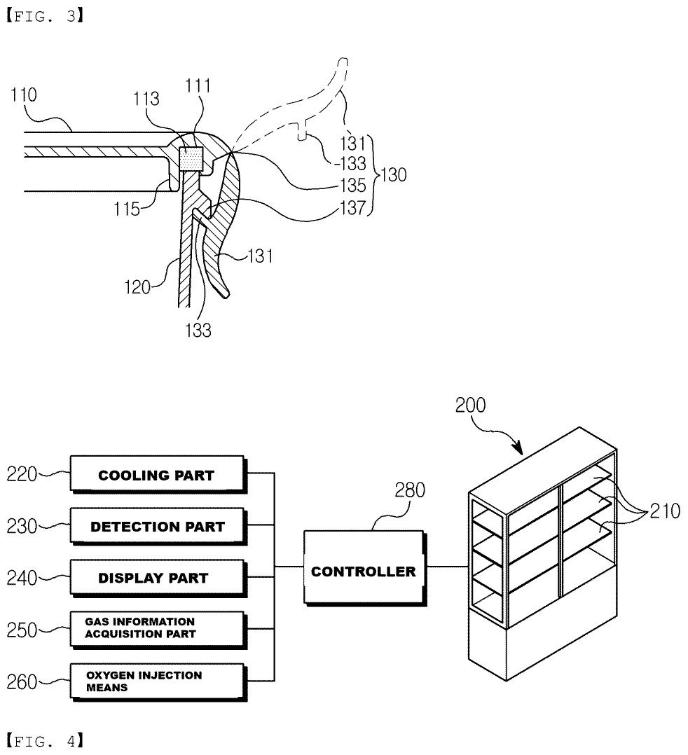

Referring to FIG. 3, a packing technology to enhance sealing force may be applied to the lid part (110) and the main body part (120).

For example, a packing groove (111) may be formed along the edge of the lid par (110) in a downward direction toward the main body par (120), and a packing member (113) may be inserted into the interior of the packing groove (111).

Furthermore, when the main body part (120) and the lid part (110) are combined, the upper portion of the edge of the main body part (120) may be configured to be in close contact with the packing member (113).

Additionally, if the inner surface (115) forming the packing groove (111) on the lid part (110) is extended downward by a certain length beyond the upper end of the edge portion of the main body part (120), the sealing performance can be further improved.

The live fish packaging container (100) may include a locking part (130) that is intermittently provided along the circumference of the main body part (120) and the lid part (110) to combine the main body part (120) and the lid part (110) with each other or to release the combined state.

FIG. 2 shows an example where four locking parts (130) are provided on each of the left and right sides of the live fish packaging container (100), but the positions and number of locking parts (130) may be varied as needed, and this is not limited to the example shown.

FIG. 3 shows a locking part (130) according to an embodiment of the present invention, wherein a hitching part (137) extending horizontally from the upper outer surface of the main body part (120) is formed at an downwardly inclined angle. Additionally, the locking wing (131) is integrally formed with the lid part (110) such that it can rotate about a thin hinge part (135) located on the outer periphery of the lid part (110), and a hook (133) is protrusively formed on the inner side of the locking wing (131) to engage with the lower side of the locking part (137), thereby firmly securing the lid part (110) to the main body part (120).

Such a locking part (130) may be configured in various ways using various sealing-related technologies and is not limited to the embodiment shown in FIG. 3.

The live fish packaging container (100) may be configured to include one or more gas sensor parts (150) for measuring the gas volume (amount of gas) present in the internal space (121).

Here, the gas may be of various types for measuring the condition of the live fish contained in the internal space (121). For example, the gas sensor part (150) may include an oxygen sensor for measuring the oxygen volume, an ammonia sensor for measuring the ammonia volume, and so on.

The gas sensor part (150) may be configured to process the measured gas quantity information in various ways. For example, the measured oxygen volume information can be visually displayed or transmitted to the outside via a wireless interface.

The gas sensor part (150) may be installed in the live fish packaging container (100) in various ways.

For example, the gas sensor part (150) may be fixedly mounted on the inner surface of the lid part (110), but this is not limited to this configuration.

The live fish display case according to the present invention is installed in various sales outlets and is intended for displaying and selling a plurality of live fish packaging containers accommodated therein with artificial hibernation-induced live fish.

Hereinafter, the live fish packaging container (100) containing artificial hibernation-induced live fish will be interchangeably referred to as ‘product.’

FIG. 4 shows a live fish display case (200) according to an embodiment of the present invention, which has a rectangular outer shape with multiple shelves (210) arranged vertically in display spaces where the products are displayed, and is equipped with transparent sliding doors.

The exterior of the live fish display case (200) is merely an example to aid in understanding the description, and the live fish display case according to the present invention may be configured in various forms as needed, and is not limited thereto.

In an embodiment of the live fish display case (200) that includes one or more shelves (210) on which products are displayed, the shelves (210) may be installed at an angle such that the front end is lower than the rear end.

By installing the shelves (210) at an angle as described above, the live fish contained in the live fish packaging containers (100) can be more easily seen by consumers, and light reflection caused by the door of the live fish display case (200) can be suppressed, making the live fish appear clearer.

The live fish display case (200) according to the present invention may be configured to include a cooling part (220), a detection part (230), a display part (240), a gas information acquisition part (250), an oxygen injection means (260), and a controller (280).

The cooling part (220) cools the display space of the live fish display case (200).

The cooling part (220) may be configured in various ways, but generally includes a compressor, condenser, expansion valve, evaporator, etc., for compressing, condensing, expanding, and exchanging heat of a refrigerant, but is not limited thereto.

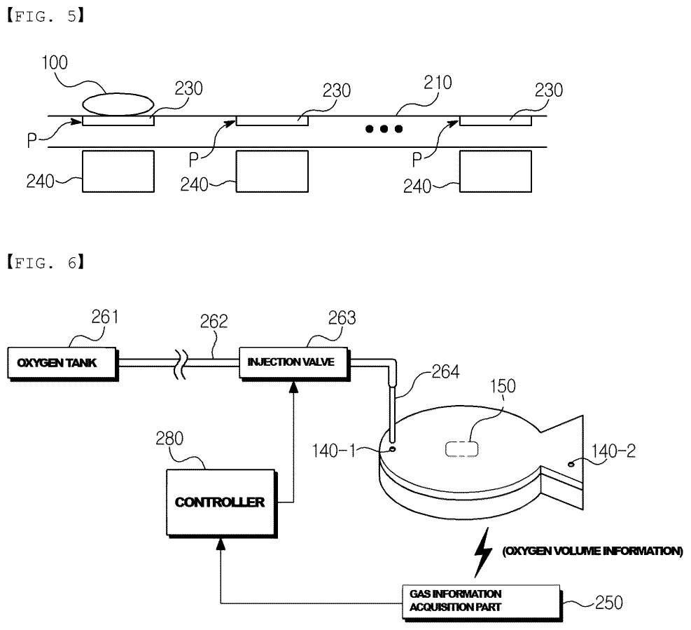

Referring to FIG. 5, the detection part (230) may detect whether or not a product is placed at each product display position (P), which corresponds to the position where each live fish packaging container (100) is displayed.

Here, a product display position (P) refers to the location where a product is displayed.

Therefore, if n products are displayed side by side horizontally on each shelf (210) in the live fish display case (200), each shelf has n product display positions (P).

The detection part (230) may be configured to detect whether products are placed at the product display positions (P) using various methods.

For example, the detection part (230) may be configured using mechanical sensors, electronic pressure sensors, optical sensors, etc., but is not limited to these.

The display part (240) may visually display various information related to the products sold through the live fish display case (200) and may be configured in various ways.

As one example, the display part (240) may be configured using an LED (Light Emitting Diode) panel or an LCD (Liquid Crystal Display) panel, but this is not limited to these.

The display part (240) may be installed in a one-to-one correspondence with each product display position (P), as shown in FIG. 5, and configured to display information about the product displayed at the corresponding product display position (P) in a distinguished manner.

Additionally, the display part (240) may be configured to display information about products displayed at two or more product display positions (P) together.

For example, the display part (240) may be installed corresponding to each shelf (210) and may display information about each product displayed on the corresponding shelf in an integrated manner.

Furthermore, the display part (240) may be configured to display information about all products displayed in the live fish display case (200) in an integrated manner.

The controller (280) may display information about each product displayed in the live fish display case (200) through the display part (240) based on the detection results from the detection part (230). The product-related information displayed by the controller (280) may be configured in various ways as needed.

For example, the controller (280) can display information about the elapsed time since each product was displayed at its respective display location on the display part (240).

In other words, when the controller (280) detects through the detection part (230) that a product display location that was previously empty has been filled with a product, it can display the elapsed time from that point on the display part (240). Since the products are live fish contained in live fish packaging containers (100) in a waterless state, this elapsed time can serve as an important indicator of the condition and quality of the live fish.

Meanwhile, to maintain the quality of live fish induced into artificial hibernation and contained in a waterless state, not only temperature but also oxygen plays a very important role.

In this regard, the live fish display case (200) may be installed around each product display position (P) and may include an oxygen injection means (260) for injecting oxygen into the oxygen injection part (140-1) of the live fish packaging container (100).

Such oxygen injection means (260) may be configured in various ways.

Referring to FIG. 6, the oxygen injection means (260) may include an oxygen tank (261) for compressing and storing oxygen, an oxygen pipe part (262) connecting the oxygen tank (261) to each product display position, an oxygen injection terminal (264) connectable to the oxygen injection part (140-1) of the live fish packaging container, and an injection valve (263) for opening and closing the oxygen pipe part (262) and the oxygen injection terminal (264), but is not limited thereto.

The gas sensor part (150) provided in each live fish packaging container (100) may transmit the measured gas quantity (e.g., oxygen volume) information to the outside via a wireless interface.

In this regard, the live fish display case (200) may include a gas information acquisition part (250) that interfaces with the gas sensor parts (150) of the live fish packaging containers (100) displayed at each product display position (P) to acquire information on the gas volume present in the internal space of each live fish packaging container (100).

The gas information obtained through the gas information acquisition part (250) may be utilized in various ways.

As an example, the controller (280) can display the gas volume information obtained through the gas information acquisition part (250) on the display part (240) to visually inform the user.

As another example, as shown in the embodiment of FIG. 6, the controller (280) may be configured to automatically control the oxygen injection means (260) based on the gas volume information obtained through the gas information acquisition part (250).

Referring to FIG. 6, the controller (280) can automatically open or close the injection valve (263) at the corresponding product display position based on the gas volume information obtained from the gas information acquisition part (250) for each product (100).

In other words, the controller (280) can open the injection valve (263) at the product display position where the live fish packaging container (100) is displayed if the residual oxygen level in the internal space of any live fish packaging container (100) falls below a certain level.

Additionally, the controller (280) can close the injection valve (263) at the product display location where the live fish packaging container (100) is displayed if the residual oxygen level in the internal space of the live fish packaging container (100) exceeds a certain level.

The above description relates to specific preferred embodiments of the present invention, but it is clear to those skilled in the art that the present invention may be modified and changed in various ways without departing from the technical features or scope of the present invention as defined by the appended claims.

### DESCRIPTION OF REFERENCE NUMERALS

100: live fish packaging container 110: lid part
111: packing groove 113: packing member
120: main body part 130: locking part
131: locking wing 133: hook
135: hinge part 137: hitching part
140-1: oxygen injection part 140-2: oxygen exhaust part
150: gas sensor part 200: live fish display case
210: shelf 220: cooling part
230: detection part 240: display part
250: gas information acquisition part 260: oxygen injection means
261: oxygen tan 262: oxygen pipe
263: injection valve 264: oxygen injection terminal
280: controller

1. A live fish packaging container comprising: a main body part having an internal space capable of accommodating artificial hibernation-induced live fish into a waterless state, and an open upper surface; a lid part covering the open upper surface of the main body; an oxygen injection part formed on the main body part or the lid part to provide a passage for oxygen to be injected into the internal space of the main body part; and an oxygen exhaust part formed on the main body part or the lid part to allow oxygen injected into the internal space of the main body to be exhausted.

2. The live fish packaging container of claim 1, further comprising one or more locking parts that are intermittently provided along the circumference of the main body part and the lid part and that serve to couple the main body part and the lid part.

3. The live fish packaging container of claim 1, characterized in that the main body part and a lid part are made of synthetic resin materials and the outer shape of the main body part and lid part are formed in the shape of a live fish.

4. The live fish packaging container of claim 1, wherein the lid part is formed with a transparent material.

5. The live fish packaging container of claim 1, further comprising one or more gas sensor parts for measuring the gas volume in the internal space.

6. The live fish packaging container of claim 5, wherein the gas sensor part includes a sensor for measuring the oxygen volume.

7. A live fish display case intended to display and sell a plurality of live fish packaging containers containing artificial hibernation-induced live fish according to claim 1, comprising: a cooling part for cooling a display space of the live fish display case; a display part for visually displaying various information; a detection part that detects whether the live fish packaging containers are displayed at each product display position, which is the location where each live fish packaging container is displayed; and a controller that displays information about the products displayed at each product display position through the display part based on the detection results of the detection part.

8. The live fish display case of claim 7, wherein the controller is configured to display the elapsed time information on the display part after the live fish packaging containers are displayed at each product display location, based on the detection results from the detection part.

9. The live fish display case of claim 7, wherein the display part is installed in a one-to-one correspondence with each product display location.

10. The live fish display case of claim 7, wherein the display part is configured to display information about products displayed at two or more of the product display locations together.

11. The live fish display case of claim 7, further comprising one or more shelves equipped with multiple product display positions, and the shelves are installed at an angle such that the front end is lower than the rear end.

12. The live fish display case of claim 7, further comprising an oxygen injection means for injecting oxygen into the oxygen injection part of each live fish packaging container displayed at each product display position.

13. The live fish display case of claim 7, further comprising a gas information acquisition part that interfaces with the gas sensor part of the live fish packaging containers displayed at each product display location to acquire information on the gas volume present in the internal space of the live fish packaging containers.

14. The live fish display case of claim 13, wherein the controller is configured to display the gas volume information obtained through the gas information acquisition part on the display part.

15. The live fish display case of claim 13, further comprising an oxygen injection means for injecting oxygen into the oxygen injection part of each live fish packaging container displayed at each product display position.

16. The live fish display case of claim 15, wherein the controller is configured to control the oxygen injection means according to the gas volume information obtained through the gas information acquisition part.
